(19) United States
(12) Patent Application Publication
(10) Pub. No.: US 2025/0111022 A1
(43) Pub. Date: Apr. 3, 2025

(54) SYSTEMS AND METHODS FOR TRANSMISSION AND CONSUMPTION OF IMAGE DATA

(71) Applicant: Apple Inc., Cupertino, CA (US)

(72) Inventors: Yung-Chin Chen, Saratoga, CA (US); William T. Warner, JR., Sunnyvale, CA (US); Joseph Cheung, San Jose, CA (US)

(21) Appl. No.: 18/407,179

(22) Filed: Jan. 8, 2024

Related U.S. Application Data
(60) Provisional application No. 63/586,367, filed on Sep. 28, 2023.

(51) Int. Cl. G06F 21/32; G06F 3/01; G06T 5/50; G06T 9/00; G06V 40/18

(52) U.S. Cl. CPC G06F 21/32; G06F 3/013; G06T 5/50; G06T 9/00; G06V 40/197; G06T 2207/20221

(57) ABSTRACT

A system including first integrated circuitry configured to obtain first image data from a first camera, obtain second image data from a second camera, compress the first image data, and combine one or more frames of the second image data into a single frame. The first integrated circuitry is configured to transmit the first image data in a compressed form and transmit the second image data in an uncompressed form via the single frame via an image data transfer protocol connection. The system includes second integrated circuitry configured to receive the first image data in the compressed form from the first integrated circuitry, decrypt the first image data, use the first image data for display on an electronic display coupled to the second integrated circuitry, receive the second image data via the single frame via the image data transfer protocol connection, and perform user authentication using the second image data.

### CROSS-REFERENCE TO RELATED APPLICATIONS

This application claims priority to U.S. Application No. 63/586,367, filed Sep. 28, 2023, entitled “System and Methods for Transmission and Consumption of Image Data,” which is incorporated by reference herein in its entirety for all purposes.

### BACKGROUND

The present disclosure generally relates to image processing and, more particularly, to transmitting compressed and uncompressed image data between different devices for display and/or authentication.

Electronic devices often use one or more authentication methods to ensure an authorized user may access an electronic device and/or sensitive information the electronic device may contain. For example, the one or more authentication methods may include a passcode or a biometric sensor (e.g., a fingerprint sensor, a facial recognition sensor) to authenticate a user of the electronic device. The electronic device may include multiple integrated circuit systems that may operate in conjunction with one another to provide a realistic experience for the user of the electronic device. It may be difficult, however, to provide separate authentication systems for each of the multiple integrated circuit systems. Additionally, compressing secure data before transmission may reduce latency. However, the compression may cause the secure data to be subject to loss of data confidentiality, increased vulnerability, decreased data integrity, and so on.

### SUMMARY

This disclosure provides systems and methods for transmission and consumption of image data, such as biometric data to authenticate a user of an electronic device. For example, an electronic device may include two integrated circuitries that may communicate biometric image data from one to another without compression while communicating other image data in a compressed format. A first of the two integrated circuitries may obtain the biometric data and a second of the two integrated circuitries may use the biometric data to authenticate the user. The first integrated circuitry may include one or more cameras that may capture biometric images (e.g., an image of a human eye) and other images (e.g., ambient background images). Additionally or alternatively, the first integrated circuitry may capture biometric data via one or more biometric sensors. The first integrated circuitry may compress image data other than biometric image data via streaming encoding or decoding circuitry and transmit the image data to the second integrated circuitry. Thus, the first integrated circuitry may avoid compressing biometric data (e.g., biometric images, data from other biometric sensors). Instead, the first integrated circuitry may provide the biometric data to the second integrated circuitry by transmitting uncompressed frames of the biometric data. The first integrated circuitry may combine multiple frames of the biometric data into a single frame (e.g., a superframe) and transmit the biometric image data via the single frame using an image data transfer protocol (e.g., DisplayPort (DP), Low Power DisplayPort (LPDP)).

The second integrated circuitry may receive the compressed image data and the uncompressed biometric data. The second integrated circuit may then decompress the image data to use for display. Moreover, the authentication system of the second integrated circuitry may perform authentication based on the uncompressed biometric data received via the image data transfer protocol. Transmitting the biometric data via the image data transfer protocol in a superframe (instead of via separate streams) may reduce latency and enable an improvement in security for the biometric data in the superframe.

### BRIEF DESCRIPTION OF THE DRAWINGS

Various aspects of this disclosure may be better understood upon reading the following detailed description and upon reference to the drawings in which:

FIG. 1 is a block diagram of an electronic device that includes an electronic display, in accordance with an embodiment;

FIG. 2 is a front view of a mobile phone representing an example of the electronic device of FIG. 1, in accordance with an embodiment;

FIG. 3 is a front view of a tablet device representing an example of the electronic device of FIG. 1, in accordance with an embodiment;

FIG. 4 is a front view of a notebook computer representing an example of the electronic device of FIG. 1, in accordance with an embodiment;

FIG. 5 is a front and side view of a watch representing an example of the electronic device of FIG. 1, in accordance with an embodiment;

FIG. 6 is a front view of a computer representing an example of the electronic device of FIG. 1, in accordance with an embodiment;

FIG. 7 is a block diagram of a system of the electronic device of FIG. 1 including first integrated circuitry in communication with second integrated circuitry, in accordance with an embodiment;

FIG. 8 is a block diagram illustrating transportation of image data between the first integrated circuitry and the second integrated circuitry, in accordance with an embodiment;

FIG. 9 is a block diagram illustrating placement of the biometric data in a superframe, in accordance with an embodiment;

FIG. 10 is a block diagram illustrating the transportation of compressed image data and uncompressed image data, in accordance with an embodiment;

FIG. 11 is a block diagram illustrating various data types included in the superframe, in accordance with an embodiment; and

FIG. 12 is a flow diagram of the transportation and consumption of the image data between the first integrated circuitry and the second integrated circuitry, in accordance with an embodiment.

### DETAILED DESCRIPTION OF SPECIFIC EMBODIMENTS

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but may nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

The present disclosure relates to transmission and consumption of image data and/or biometric data (e.g., secure data) between first integrated circuitry and second integrated circuitry. The second integrated circuitry may include an authentication system that may authenticate a user based on biometric data received from the first integrated circuitry. Additionally, the first integrated circuitry may include one or more cameras, which may capture one or more images of a user and/or an environment. The first integrated circuitry may receive image data associated with the one or more images from the one or more cameras and capture the biometric data.

The first integrated circuitry may also include streaming encoding or decoding circuitry, which may implement a compression protocol to compress the image data. The first integrated circuitry may then transmit the image data (or any other suitable data, such as audio data and/or video data) to second integrated circuitry via the streaming encoding or decoding circuitry. Further, the first integrated circuitry may combine (e.g., stitch) multiple frames of the image data from the one or more cameras into a superframe. The first integrated circuitry may then transmit the uncompressed image data (e.g., as a superframe) corresponding to the biometric data (according to an image data protocol). The image data protocol is a protocol that enables the transfer of the biometric data between the first integrated circuitry and the second integrated circuitry.

The second integrated circuitry may receive the compressed image data and the biometric data. The second integrated circuitry may also include streaming encoding or decoding circuitry, which may decompress the image data to enable the second integrated circuitry to use the image data for display. Additionally, the authentication system of the second integrated circuitry may perform authentication based on the biometric data received via the image data transfer protocol (e.g., as multiple uncompressed frames; as a superframe combining biometric data from multiple sources, such as two image frames from two eye-facing cameras). As such, transmitting the biometric data via the superframe (instead of via separate streams) may reduce latency in transmission of the biometric data and enable an improvement in secure transmission of the biometric data in the superframe. Further, transmitting the compressed image data and the uncompressed image data may reduce latency in the transmission of the image data and the biometric data.

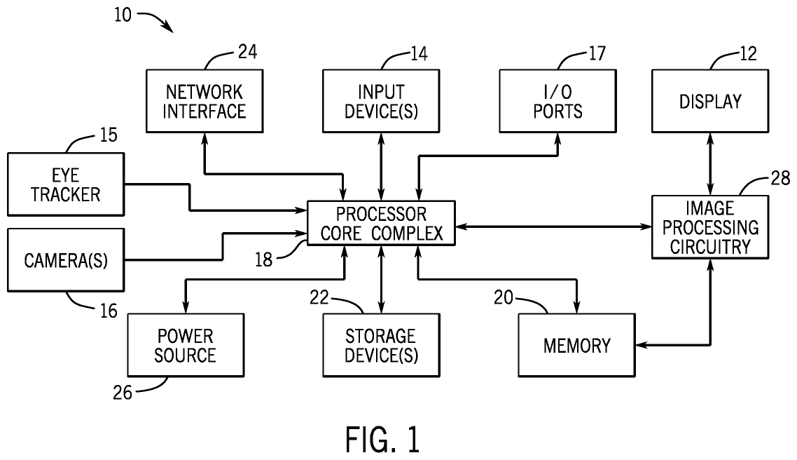

With the foregoing in mind, FIG. 1 is an example electronic device 10 that may use such a system to authenticate a user. As described in more detail below, the electronic device 10 may be any suitable electronic device, such as a computer, a mobile phone, a portable media device, a tablet, a television, a virtual-reality headset, a wearable device such as a watch, a vehicle dashboard, or the like. Thus, it should be noted that FIG. 1 is merely one example of a particular implementation and is intended to illustrate the types of components that may be present in an electronic device 10.

The electronic device 10 may include one or more electronic displays 12, input devices 14, an eye tracker 15, one or more cameras 16, input/output (I/O) ports 17, a processor core complex 18 having one or more processors or processor cores, local memory 20, a main memory storage device 22, a network interface 24, a power source 26, and image processing circuitry 28. The various components described in FIG. 1 may include hardware elements (e.g., circuitry), software elements (e.g., a tangible, non-transitory computer-readable medium storing instructions), or a combination of both hardware and software elements. As should be appreciated, the various components may be combined into fewer components or separated into additional components. For example, the local memory 20 and the main memory storage device 22 may be included in a single component. Moreover, the image processing circuitry 28 (e.g., a graphics processing unit, a display image processing pipeline) may be included in the processor core complex 18 or be implemented separately.

The processor core complex 18 is operably coupled with local memory 20 and the main memory storage device 22. Thus, the processor core complex 18 may execute instructions stored in local memory 20 or the main memory storage device 22 to perform operations, such as generating or transmitting image data to display on the electronic display 12. As such, the processor core complex 18 may include one or more general purpose microprocessors such as reduced instruction set computing (RISC) processors, one or more application specific integrated circuits (ASICs), one or more field programmable gate arrays (FPGAs), or any combination thereof.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a Bluetooth network, a local area network (LAN), such as an 802.11x Wi-Fi network, or a wide area network (WAN), such as a 4G, Long-Term Evolution (LTE), or 5G cellular network.

The power source 26 may provide electrical power to operate the processor core complex 18 and/or other components in the electronic device 10. Thus, the power source 26 may include any suitable source of energy, such as a rechargeable lithium polymer (Li-poly) battery and/or an alternating current (AC) power converter.

The I/O ports 17 may enable the electronic device 10 to interface with various other electronic devices. For example, when a portable storage device is connected, the I/O port 17 may enable the processor core complex 18 to communicate data with the portable storage device. Moreover, the input devices 14 may enable a user to interact with the electronic device 10. For example, the input devices 14 may include buttons, keyboards, mice, trackpads, and the like. Additionally or alternatively, the electronic display 12 may include touch sensing components that enable user inputs to the electronic device 10 by detecting occurrence and/or position of an object touching its screen (e.g., surface of the electronic display 12).

Additionally, the electronic display 12 may be a display panel with one or more display pixels. For example, the electronic display 12 may include a self-emissive pixel array having an array of one or more of self-emissive pixels or liquid crystal pixels. The electronic display 12 may include any suitable circuitry (e.g., display driver circuitry) to drive the self-emissive pixels, including for example row driver and/or column drivers (e.g., display drivers). Each of the self-emissive pixels may include any suitable light emitting element, such as an LED (e.g., an OLED or a micro-LED). However, any other suitable type of pixel, including non-self-emissive pixels (e.g., liquid crystal as used in liquid crystal displays (LCDs), digital micromirror devices (DMD) used in DMD displays) may also be used. The electronic display 12 may control light emission from the display pixels to present visual representations of information, such as a graphical user interface (GUI) of an operating system, an application interface, a still image, or video content, by displaying frames of image data. To display images, the electronic display 12 may include display pixels implemented on the display panel. The display pixels may represent sub-pixels that each control a luminance value of one-color component (e.g., red, green, or blue for an RGB pixel arrangement or red, green, blue, or white for an RGBW arrangement). As used herein, a display pixel may refer to a collection of sub-pixels (e.g., red, green, and blue subpixels) or may refer to a single sub-pixel.

Additionally, the electronic display 12 may control light emission from the display pixels to present visual representations of information based on image data corresponding to the visual representations of information. For example, the electronic display 12 may present graphics including a graphical user interface (GUI) of an operating system, an application interface, a still image, video content, or the like, by displaying frames based at least in part on image data. In particular, the electronic display 12 may be operably coupled to the processor core complex 18 and the image processing circuitry 28 so that the electronic display 12 may display frames based on the image data generated by the processor core complex 18, the image processing circuitry 28, or the like. As will be described herein, the electronic display 12 may receive the frames of image data via the network interface 24, the input devices 14, and/or the I/O ports 17, for example, captured by one or more cameras 16. In some embodiments, the electronic display 12 may represent multiple displays that may display image data corresponding to a left eye and a right eye that is perceived as a single frame.

The one or more cameras 16 may respectively be positioned facing toward the viewer (e.g., one or both eyes of the viewer, a face of the viewer, one or both hands of the viewer, body of the viewer, and the like) and/or facing an environment surrounding the viewer. For example, the one or more cameras 16 may include four cameras (e.g., a top left camera, a top right camera, a bottom left camera, and a bottom right camera) facing toward one or both eyes of the viewer. As another example, in some embodiments, the one or more cameras 16 may include six additional cameras respectively facing outward and down, outward and to the sides, and/or toward a jaw (e.g., a mouth) of the viewer. As another example, in some embodiments, the one or more cameras 16 may include two additional cameras each facing outward toward the general environment. As yet another example, in some embodiments, the one or more cameras 16 may include two additional cameras including a short-range depth camera (e.g., a short-range depth sensor) and a long-range depth camera (e.g., a long-range depth sensor). The image data captured by the short-range depth camera and the long-range depth camera may be combined with the image data captured from the two additional cameras facing the general environment to enable creation of a three-dimensional scene of an environment. In this manner, the one or more cameras 16 may capture image data associated with the viewer and/or the environment.

The eye tracker 15 may measure positions and movement of one or both eyes of someone viewing the electronic display 12 of the electronic device 10. For instance, the eye tracker 15 may include a camera (e.g., the camera 16) that can record the movement of a viewer's (e.g., a user's) eyes as the viewer looks at the electronic display 12. However, several different practices may be employed to track a viewer's eye movements. For example, different types of infrared/near infrared eye tracking techniques such as bright-pupil tracking and dark-pupil tracking may be used. In both of these types of eye tracking, infrared or near infrared light is reflected off of one or both of the eyes of the viewer to create corneal reflections. A vector between the center of the pupil of the eye and the corneal reflections may be used to determine a point on the electronic display 12 at which the viewer is looking. The processor core complex 18 may use the gaze angle(s) of the eyes of the viewer when generating/processing image data for display on the electronic display 12. Further, the processor core complex 18 may use iris data or retina data of one or both of the eyes of the viewer to capture biometric data and perform authentication.

As described above, the electronic display 12 may display an image by controlling the luminance output (e.g., light emission) of the sub-pixels based on corresponding image data. In some embodiments, pixel or image data may be generated by an image source, such as the processor core complex 18, a graphics processing unit (GPU), or an image sensor (e.g., the camera 16). Additionally, in some embodiments, image data may be received from another electronic device 10, for example, via the network interface 24 and/or an I/O port 17. Moreover, in some embodiments, the electronic device 10 may include multiple electronic displays 12 and/or may perform image processing (e.g., via the image processing circuitry 28) for one or more external electronic displays 12, such as connected via the network interface 24 and/or the I/O ports 17.

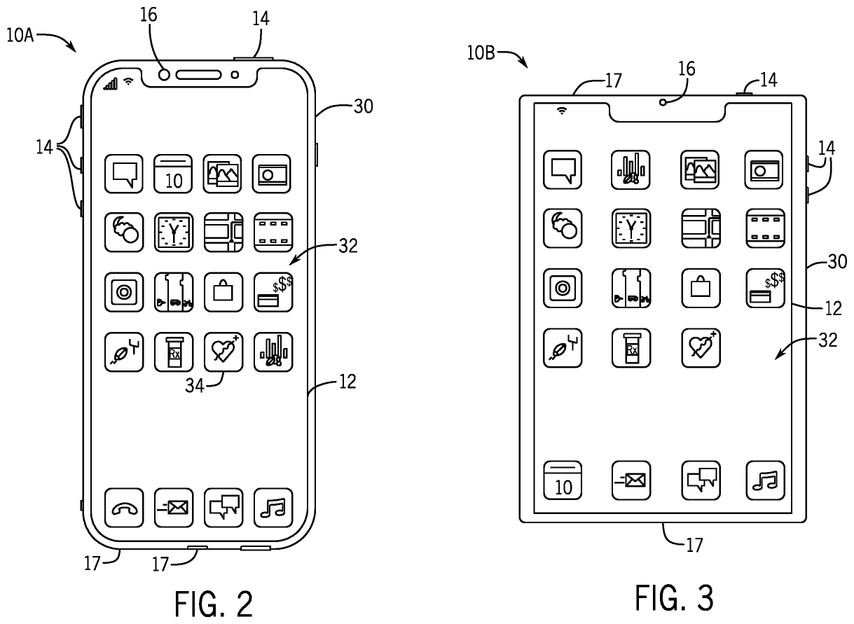

The electronic device 10 may be any suitable electronic device. To help illustrate, one example of a suitable electronic device 10, specifically a handheld device 10A, is shown in FIG. 2. In some embodiments, the handheld device 10A may be a portable phone, a media player, a personal data organizer, a handheld game platform, and/or the like. For illustrative purposes, the handheld device 10A may be a smartphone, such as an IPHONE® model available from Apple Inc.

The handheld device 10A may include an enclosure 30 (e.g., housing) to, for example, protect interior components from physical damage and/or shield them from electromagnetic interference. The enclosure 30 may surround, at least partially, the electronic display 12. In the depicted embodiment, the electronic display 12 is displaying a graphical user interface (GUI) 32 having an array of icons 34. By way of example, when an icon 34 is selected either by an input device 14 or a touch-sensing component of the electronic display 12, an application program may launch.

Input devices 14 may be accessed through openings in the enclosure 30. Moreover, the input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, and/or toggle between vibrate and ring modes. Moreover, the I/O ports 17 may also open through the enclosure 30. Additionally, the electronic device may include one or more cameras 16 to capture pictures or video. In some embodiments, a camera 16 may be used in conjunction with a virtual reality or augmented reality visualization on the electronic display 12.

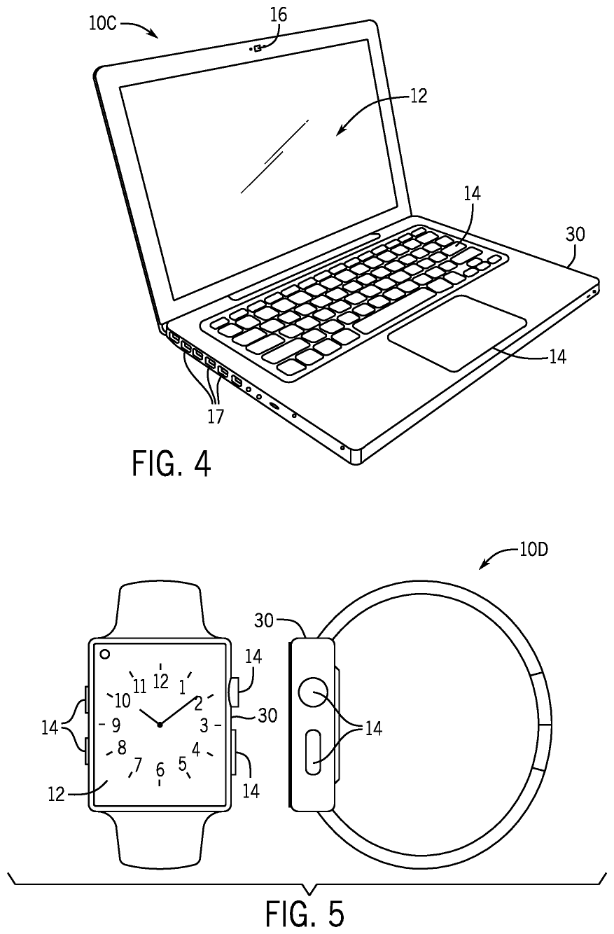

Another example of a suitable electronic device 10, specifically a tablet device 10B, is shown in FIG. 3. For illustration purposes, the tablet device 10B may be any IPAD® model available from Apple Inc. A further example of a suitable electronic device 10, specifically a computer 10C, is shown in FIG. 4. For illustrative purposes, the computer 10C may be any MACBOOK® or IMAC® model available from Apple Inc. Another example of a suitable electronic device 10, specifically a watch 10D, is shown in FIG. 5. For illustrative purposes, the watch 10D may be any APPLE WATCH® model available from Apple Inc. As depicted, the tablet device 10B, the computer 10C, and the watch 10D each also includes an electronic display 12, input devices 14, I/O ports 17, and an enclosure 30. The electronic display 12 may display a GUI 32. Here, the GUI 32 shows a visualization of a clock. When the visualization is selected either by the input device 14 or a touch-sensing component of the electronic display 12, an application program may launch, such as to transition the GUI 32 to presenting the icons 34 discussed in FIGS. 2 and 3.

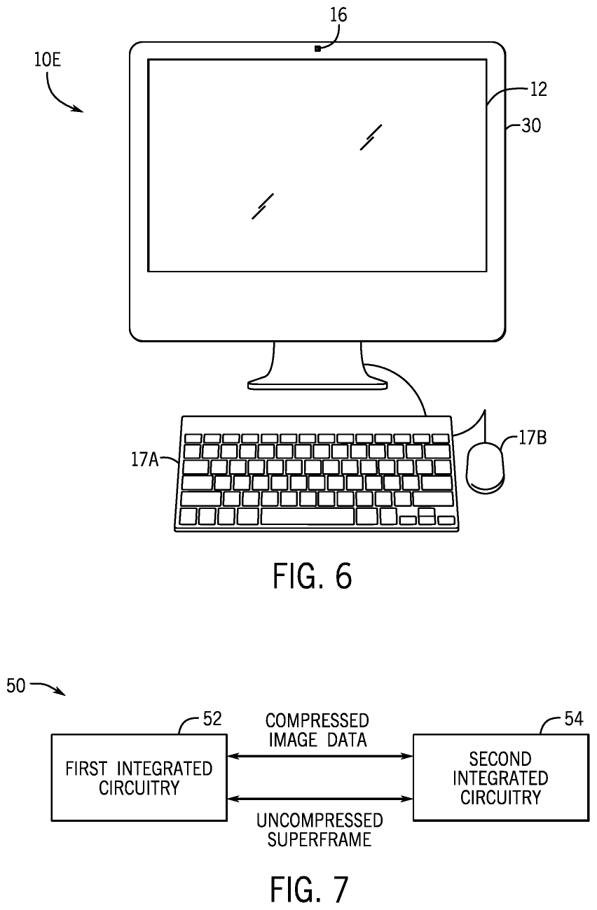

Turning to FIG. 6, a computer 10E may represent another embodiment of the electronic device 10 of FIG. 1. The computer 10E may be any suitable computer, such as a desktop computer, a server, or a notebook computer, but may also be a standalone media player or video gaming machine. By way of example, the computer 10E may be an IMAC®, a MACBOOK®, or other similar device by Apple Inc. of Cupertino, California. It should be noted that the computer 10E may also represent a personal computer (PC) by another manufacturer. A similar enclosure 30 may be provided to protect and enclose internal components of the computer 10E, such as the electronic display 12. In certain embodiments, a user of the computer 10E may interact with the computer 10E using various peripheral input devices 14, such as a keyboard 14A or mouse 14B, which may connect to the computer 10E.

As described above, the electronic display 12 may display images based at least in part on image data. Before being used to display a corresponding image on the electronic display 12, the image data may be processed, for example, via the image processing circuitry 28. Moreover, the image processing circuitry 28 may process the image data for display on one or more electronic displays 12. For example, the image processing circuitry 28 may include a display pipeline, memory-to-memory scaler and rotator (MSR) circuitry, warp compensation circuitry, or additional hardware or software means for processing image data. The image data may be processed by the image processing circuitry 28 to reduce or eliminate image artifacts, compensate for one or more different software or hardware related effects, and/or format the image data for display on one or more electronic displays 12. As should be appreciated, the present techniques may be implemented in standalone circuitry, software, and/or firmware, and may be considered a part of, separate from, and/or parallel with a display pipeline or MSR circuitry.

FIG. 7 is a block diagram of a system 50 of the electronic device of FIG. 1 including first integrated circuitry 52 (e.g., a first integrated circuit, a first integrated circuit package formed from multiple integrated circuits in a package, a first portion of a first integrated circuit) in communication with second integrated circuitry 54 (e.g., a second integrated circuit, a second integrated circuit package formed from multiple integrated circuits in a package, a second portion of the first integrated circuit), in accordance with an embodiment. As illustrated in FIG. 7, the first integrated circuitry 52 may transmit (e.g., send) compressed image data to the second integrated circuitry 54. For example, the compressed image data may include image data of the environment surrounding the user, image data associated with eye tracking (e.g., gaze tracking, expression tracking), or any other suitable image data unrelated to the biometric data (e.g., secure data) captured by the one or more cameras 16.

The first integrated circuitry 52 may also transmit an uncompressed superframe, which may include the biometric data used in authentication. That is, the first integrated circuitry 52 may capture biometric data from image data provided by the one or more cameras 16. The first integrated circuitry 52 may combine multiple frames of the image data associated with the biometric data captured by the one or more cameras 16. For example, the first integrated circuitry 52 may receive a first frame of image data from a first camera and a second frame of image data from a second camera. The first integrated circuitry 52 may combine the first frame of image data and the second frame of image data into a single superframe (without compression). The single superframe may be a frame structure that is used to hold multiple smaller frames and data. That is, each smaller frame may be combined or stitched together into the single frame (e.g., a single large frame). The first integrated circuitry 52 may then transmit the single superframe to the second integrated circuitry 54.

In some embodiments, the second integrated circuitry 54 may capture image data from the one or more cameras 16 and transmit the compressed image data to the first integrated circuitry. Additionally or alternatively, the second integrated circuitry 54 may combine the multiple frames of image data associated with biometric data into the single superframe and transmit the single superframe to the first integrated circuitry 52. In this manner, the first integrated circuitry 52 and the second integrated circuitry 54 may each transmit and/or receive the compressed image data and the uncompressed superframe. Additional details regarding transmission and consumption of the image data between the first integrated circuitry 52 and the second integrated circuitry 54 will be discussed below.

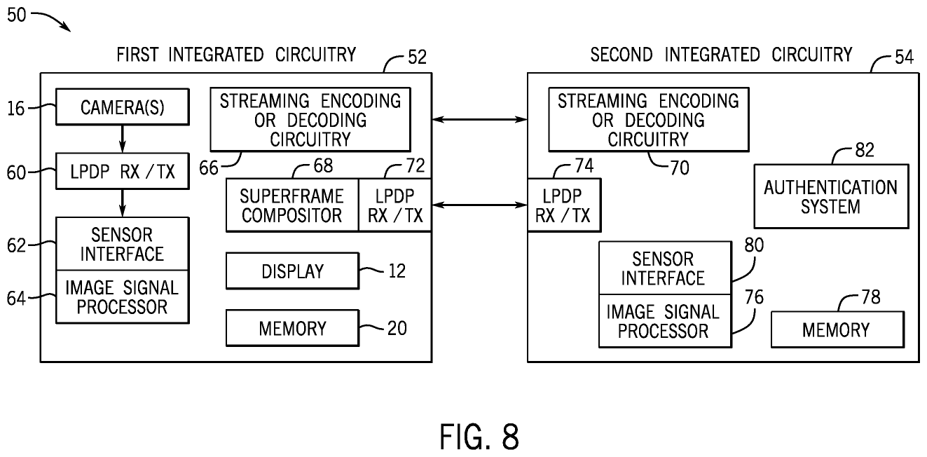

With the foregoing in mind, FIG. 8 is a block diagram illustrating transportation of image data between the first integrated circuitry 52 and the second integrated circuitry 54. The first integrated circuitry 52 may include the one or more cameras 16 that capture the image data and provide the image data to the first integrated circuitry 52 via a link 60 that uses an image data transfer protocol such as DisplayPort (DP), Low Power DisplayPort (LPDP), or Mobile Interface Processor Interface (MIPI). For purposes of this discussion, the link 60 may be referred to as an LPDP link, but may take any other suitable form. The image data may be associated with gaze tracking data, continuity data, iris identification data, and/or anti-spoofing data (e.g., data that may enable prevention and/or detection of attempts to deceive a system using false or counterfeit information). The continuity data, the iris identification data, and/or the anti-spoofing data may contain the biometric data that may be used by the second integrated circuitry 54. In some embodiments, other biometric data such as face data, fingerprint data, car shape data, motion data (e.g., gait data), audio data (e.g., voice data) may also be used be the second integrated circuitry 54.

It should be noted that each of the first integrated circuitry 52 and the second integrated circuitry 54 may be included on a single integrated circuit package, or may each be respectively integrated on separate integrated circuit packages. In other words, the first integrated circuitry 52 and the second integrated circuitry 54 may be separate devices or may be components of a single device. Further, either the first integrated circuitry 52 or the second integrated circuitry 54 may receive captured image data from the cameras 16 and transmit the compressed image data and/or the uncompressed biometric data to each other. It should also be noted that each of the first integrated circuitry 52 and the second integrated circuitry 54 may be included on a single integrated circuit package, or may each be respectively integrated on separate integrated circuit packages. In other words, the first integrated circuitry 52 and the second integrated circuitry 54 may be separate devices or may be components of a single device.

The image data may include a number of frames each associated with a respective camera 16. For example, a first camera may capture and transmit a frame of first image data, a second camera may capture and transmit a frame of second image data, a third camera may capture and transmit a frame of third image data, and so on. In some embodiments, at least some of the one or more cameras 16 may be set to operate in a security mode. Thus, the one or more cameras 16 that are set to the security mode may each output a secure image, which includes a security signature.

The LPDP link 60 may include corresponding LPDP receive (RX) circuitry and/or transmit (TX) circuitry. Additionally, the LPDP link 60 may be tunneled over a wired communication protocol (e.g., Universal Serial Bus (USB) 2, USB 3, USB 4, and so on). In some embodiments, the image data may be communicated between the one or more cameras 16 and the first integrated circuitry 52 via a wireless link. It should be noted that although communication is discussed as using USB and the LPDP link 60 over a wired connection, any suitable communication method, protocol, and/or standard may be used. Further, it should be noted that any additional number of LPDP links may be included in the first integrated circuitry 52 and/or the second integrated circuitry 54. For example, the first integrated circuitry 52 and/or the second integrated circuitry 54 may include 3 LPDP links, 5 LPDP links, and so on. Each LPDP link may transmit and/or receive a respective superframe.

The first integrated circuitry 52 may include a sensor interface 62 (e.g., a component or a subsystem, an image data transfer interface), which may facilitate connection and communication between the one or more cameras 16, a processing system (e.g., the processor core complex 18, image signal processor 64), the memory 20, and/or a superframe compositor 68. For example, the first integrated circuitry 52 may receive the image data and send the image data to the sensor interface 62 via the LPDP link 60. The sensor interface 62 may transfer (e.g., transmit, send) the image data to the processing system, the memory 20, and/or the superframe compositor 68. In some embodiments, each of the one or more cameras 16 may be associated with a respective sensor interface 62. Thus, each sensor interface 62 may handle synchronization between one another to enable the image data from each of the one or more cameras 16 to be received and/or transferred in a coordinated manner.

The superframe compositor 68 may receive at least two frames of biometric data. Additionally, the superframe compositor 68 may arrange or place each of the received frames of the biometric data into the superframe (as a single frame). Each of the received frames of the biometric data may be arranged or placed without compression (e.g., uncompressed). The superframe compositor 68 may then transmit (e.g., send) the superframe as the uncompressed superframe to the second integrated circuitry 54 via the LPDP link 72. The uncompressed superframe may include the biometric data used for authentication. In some embodiments, the size of the superframe may be fixed for each LPDP link 72.

In some embodiments, the first integrated circuitry 52 may communicate the image data to the image signal processor 64 (e.g., image signal processor(s)). The image signal processor 64 may include a hardware component and/or a software algorithm that may enable processing of the image data received by the one or more cameras 16. The image data may be processed and converted into a usable image or video format for storing in the memory and/or for display. Further, the image signal processor 64 may enable enhancement and/or improvement of quality of the image data captured by the one or more cameras 16. In some embodiments, the image signal processor 64 may store and/or transfer the processed image data (or a portion of the image data) to the memory 20 for additional processing, editing, displaying on the electronic display 12, and/or storage.

As described herein, the image data may be transferred from the sensor interface 62 to the memory 20. The first integrated circuitry 52 may then capture the biometric data. For example, the first integrated circuitry 52 may receive the first frame from the first camera, the second frame from the second camera, and the third frame from the third camera. The first integrated circuitry 52 may identify the first frame is associated with normal image data (of the viewer and/or the environment). Additionally the first integrated circuitry 52 may identify the second frame and the third frame are associated with biometric data (e.g., secure data) of the viewer. Thus, the first integrated circuitry 52 may compress the first frame via streaming encoding or decoding circuitry 66. The streaming encoding or decoding circuitry 66 may implement an image compression protocol (e.g., Apple Professional Quality Intermediate Codec, a ProRES codec) to compress the image data. Further, the first integrated circuitry 52 may combine the second frame and the third frame in the superframe (without compression).

The first integrated circuitry 52 may then transmit the compressed first frame of image data via the streaming encoding or decoding circuitry 66 to streaming encoding or decoding circuitry 70 of the second integrated circuitry 54. Additionally, the first integrated circuitry 52 may transmit the second frame and the third frame of image data via the superframe. The first integrated circuitry 52 and the second integrated circuitry 54 may each include LPDP links 72, 74 to enable communication (e.g., transmission and reception) between one another. The LPDP links 72, 74 may be similar to and/or the same as the LPDP link 60. In some embodiments, the uncompressed biometric data may be sent one frame at a time.

The second integrated circuitry 54 may receive the compressed first frame via the streaming encoding or decoding circuitry 70. Further, the streaming encoding or decoding circuitry 70 may decompress the first frame using the image compression protocol. The streaming encoding or decoding circuitry 70 may send (e.g., transfer) the first frame to an image signal processor 76 of the second integrated circuitry 54 or write the first frame directly to a memory 78 of the second integrated circuitry 54. The image signal processor 76 may be similar to and/or the same as the image signal processor 64. If the first frame is sent to the image signal processor 76, then the first frame may be processed and written to the memory 78. The first frame may be written to the memory 78 to enable displaying the first frame of image data on a display (e.g., the display 12, or any other suitable display in communication and/or associated with the second integrated circuitry 54).

The second integrated circuitry 54 may receive the superframe, including the biometric data, via the LPDP link 74. Moreover, the second integrated circuitry 54 may include a sensor interface 80, which may facilitate connection and communication between the LPDP link 74, the image signal processor 76, the memory 78, and/or an authentication system 82. In some embodiments, such as when the superframe contains encrypted biometric data, where each frame includes a security signature, the sensor interface 80 may send the superframe to the authentication system 82. The authentication system 82 may decrypt the security signature and enable or perform validation or authentication.

In other embodiments, the sensor interface 80 may write the superframe directly to the memory 78 (without modifying the superframe). The authentication system 82 may include a system designed to verify identity of a user before enabling access to a device. The authentication system 82 may use the biometric data received in the superframe to perform authentication (e.g., verification) of the user. As described herein, the biometric data may be based on the iris identification data, the continuity data, and/or the anti-spoofing data.

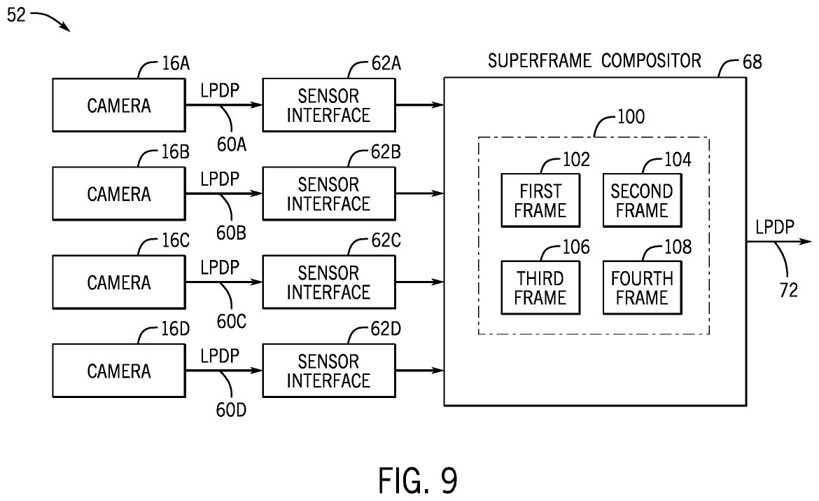

With the foregoing in mind, FIG. 9 is a block diagram illustrating placement of the biometric data in a superframe 100, in accordance with an embodiment. During authentication or initialization, the second integrated circuitry 54 may use the biometric data, which may include the iris identification data and/or the anti-spoofing data to perform the authentication or the initialization. Iris identification data may enable identification of a user of the electronic device 10 (or any other suitable device). That is, an iris of the user enables identification of the user and determination of an associated between the user and the electronic device 10. As an example, the electronic device 10 may include the headset. The user may power on the headset, and the headset may retrieve the iris identification data to verify the identity of the user.

Thus, as illustrated in FIG. 9, the first integrated circuitry 52 may include a first camera 16A, a second camera 16B, a third camera 16C, and a fourth camera 16D. Each of the cameras 16 may be positioned on a top, a bottom, a left, and/or a right portion of the electronic device 10 facing toward one or both eyes of the user. For example, the first camera 16A may be a top left camera, the second camera 16B may be a top right camera, the third camera 16C may be a bottom left camera, and the fourth camera 16D may be a bottom right camera. The first camera 16A may capture a first frame 102 of image data, the second camera 16B may capture a second frame 104 of image data, the third camera 16C may capture a third frame 106 of image data, and the fourth camera 16D may capture a fourth frame 108 of image data.

In some embodiments, each of the cameras 16 may be set to a security mode, thus, each of the first frame 102, the second frame 104, the third frame 106, and the fourth frame 108 may each be a secure frame, and may each include a secure signature (e.g., a digital signature). In some embodiments, a frame associated with a left eye and a frame associated with a right eye may be captured and received simultaneously to enable proper authentication.

The first integrated circuitry 52 may receive the first frame 102 at a first sensor interface 62A (e.g., via a first LPDP link 60A), the second frame 104 at a second sensor interface 62B (e.g., via a second LPDP link 60B), the third frame 106 at a third sensor interface 62C (e.g., via a third LPDP link 60C), and the fourth frame 108 at a fourth sensor interface 62D (e.g., via a fourth LPDP link 60D). Moreover, the first sensor interface 62A may transfer the first frame 102 to the superframe compositor 68, the second sensor interface 62B may transfer the second frame 104 to the superframe compositor 68, the third sensor interface 62C may transfer the third frame 106 to the superframe compositor 68, and the fourth sensor interface 62D may transfer the fourth frame 108 to the superframe compositor 68. Each of the sensor interfaces 62 may handle synchronization between one another to enable the first frame 102, the second frame 104, the third frame 106, and/or the fourth frame 108 to be received in a coordinated manner (e.g., simultaneously) at the superframe compositor 68 and sent in the coordinated manner.

As described herein, the superframe compositor 68 may place or arrange the first frame 102, the second frame 104, the third frame 106, and the fourth frame 108 within the superframe 100 without compression. For example, the first frame 102 may include the top left camera frame and may be placed in the top left corner of the superframe 100 and the second frame 104 may include the top right camera frame and may be placed in the top right corner of the superframe 100. As another example, the third frame 106 may include the bottom left camera frame and may be placed in the bottom left corner of the superframe 100 and the fourth frame 108 may include the bottom right camera frame and may be placed in the bottom right corner of the superframe 100. The superframe compositor 68 may then transmit the superframe 100 to the second integrated circuitry 54 via the LPDP link 72. The superframe 100 may be transmitted in a raster scan order. It should be noted that although four cameras are described above with respect to FIG. 9, any suitable number of cameras may be implemented in the capturing of the biometric data. For example, the illustrated embodiment may include two cameras, six cameras, eight cameras, and so on.

In some embodiments, an iris identification frame may include a full resolution frame (e.g., 1280×1280 10 bpp) and may be running at a display frames per second (e.g., 90, 100, 120) for multiple frames. Metadata for the iris identification data may be generated by the cameras 16 or the image signal processor 64. Further, the anti-spoofing data may also be encrypted and include the security signature (e.g., be digitally signed). The anti-spoofing data may also include the full resolution frame and may be running at the display frames per second. Metadata for the anti-spoofing data may also be generated by the sensor. Further, additional metadata associated with the iris identification data and the anti-spoofing data may be provided by the image signal processor (e.g., 64, 76). Further, an external general-purpose input/output (GPIO) port (e.g., the I/O port 17) may drive the cameras 16 to enforce a non-encryption mode or an encryption mode. For example, GPIO high may represent the non-encryption mode and GPIO low may represent the encryption mode (e.g., anti-spoofing mode).

Accordingly, transmitting the secure frames (e.g., the first frame 102, the second frame 104, the third frame 106, and the fourth frame 108) via the superframe 100, without compression, may enable minimization or reduction in a loss of data confidentiality, vulnerability, and/or decreased data integrity. Furthermore, transmitting the secure frames via the superframe 100, without compression, may improve latency in communication.

At times, ownership of the electronic device 10 may change. That is, the user may cease use of the electronic device 10 (and/or remove the electronic device 10) and a different or additional user may begin use of the electronic device 10. Thus, the electronic device 10 may identify continuity of use of the electronic device 10 to determine whether the user (e.g., a current user) has completed authentication, or if the additional user is currently initializing the electronic device 10 without completing authentication.

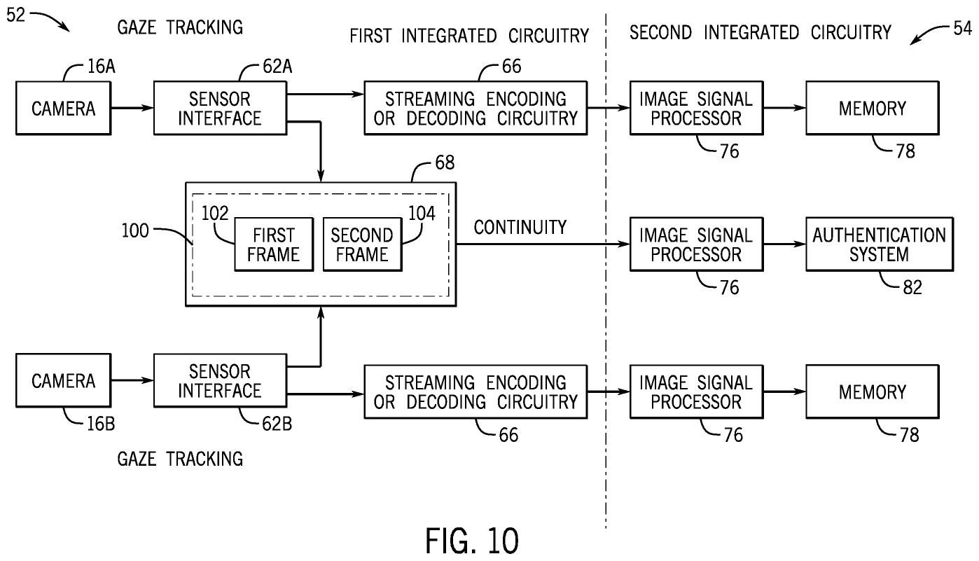

With the foregoing in mind, FIG. 10 is a block diagram illustrating the transportation of the compressed image data and the superframe 100 (e.g., uncompressed superframe), in accordance with an embodiment. In some embodiments, the cameras 16 may enable gaze tracking of the user. The first integrated circuitry 52 may transmit the gaze tracking data to the second integrated circuitry 54 via the streaming encoding or decoding circuitry 66. However, the iris identification data may continue transportation via the superframe 100 to the second integrated circuitry 54. Further, the first integrated circuitry 52 may support identification or monitoring of the continuity of use of the electronic device 10.

Identification or monitoring of the continuity of use may be a secure mechanism that enables detection of the user without performance of full authentication. Continuity data may include the frame with the security signature, which may be sent periodically over a time period (e.g., every second, every two seconds, and so on) with the gaze tracking data. Further, the continuity data may enable the electronic device 10 to determine whether authentication may be repeated for an additional user or may be omitted for the same user. Thus, the first integrated circuitry 52 may send continuity data via the superframe 100 in parallel with the gaze tracking data sent via the streaming encoding or decoding circuitry 66. Additional detail regarding the parallel transportation will be discussed below with respect to FIG. 10.

As illustrated, the first integrated circuitry 52 may include the first camera 16A and the second camera 16B. The first camera 16A may capture a first set of images and the second camera 16B may capture a second set of images. The first set of images and/or the second set of images may include image data associated with the gaze tracking data and/or the continuity data. The first set of images (e.g., first image data) may be received by the first sensor interface 62A and may be split (e.g., divided) into first gaze tracking data and first continuity data. Additionally, the second set of images may be received by the second sensor interface 62B and may be split into second gaze tracking data and second continuity data.

The first gaze tracking data may be sent to the streaming encoding or decoding circuitry 66 and the first continuity data may be sent to the superframe compositor 68. The streaming encoding or decoding circuitry 66 may implement the image compression protocol to compress the first gaze tracking data and transmit the first gaze tracking data to the second integrated circuitry 54. Further, the superframe compositor 68 may receive the first continuity data and arrange one or more frames of the first continuity data in the superframe 100.

The second integrated circuitry 54 may receive the compressed first gaze tracking data via the streaming encoding or decoding circuitry 70. Moreover, the second integrated circuitry 54 may also receive the superframe 100 via the LPDP links (e.g., 72, 74). The streaming encoding or decoding circuitry 70 may decompress the first gaze tracking data using the image compression protocol and send the first gaze tracking data to the image signal processor 76 and/or the memory 78.

In parallel (e.g., at a same or similar time) to above, the second gaze tracking data may be sent to the streaming encoding or decoding circuitry 66 and the second continuity data may be sent to the superframe compositor 68. The streaming encoding or decoding circuitry 66 may implement the image compression protocol to compress the second gaze tracking data and transmit the second gaze tracking data to the second integrated circuitry 54. Additionally, the superframe compositor 68 may receive the second continuity data and arrange the one or more frames of the second continuity data with the first continuity data. For example, the superframe compositor 68 may arrange the first continuity data (e.g., the first frame 102) on a left portion of the superframe 100 and the second continuity data (e.g., the second frame 104) on a right portion of the superframe 100. It should be noted that the one or more frames of the first continuity data and the one or more frames of the second continuity data may be arranged by the superframe compositor 68 simultaneously (at the same time or at a similar time). The superframe compositor 68 may then transmit the second continuity data to the second integrated circuitry 54 via the superframe 100.

The second integrated circuitry 54 may receive the compressed second gaze tracking data via the streaming encoding or decoding circuitry 70. The streaming encoding or decoding circuitry 70 may decompress the second gaze tracking data using the image compression protocol and send the second gaze tracking data to the image signal processor 76 and/or the memory 78. Further, the second integrated circuitry 54 may receive the superframe 100 via the LPDP links (e.g., 72, 74) and may send the superframe 100 to the image signal processor 76 for decryption of the security signature. It should be noted that although the first camera 16A and the second camera 16B are described above, any suitable number of cameras may be used in the capturing of the gaze tracking data and/or the continuity data.

Accordingly, the continuity data may enable the second integrated circuitry 54 to determine whether the authentication may be repeated for an additional user or may be omitted for the same user. Thus, operational power of the second integrated circuitry 54 may be improved or increased due to a reduction or minimization of the authentication process. Further, transportation of the continuity data via the superframe 100 may reduce latency by sending the continuity data via a dedicated channel.

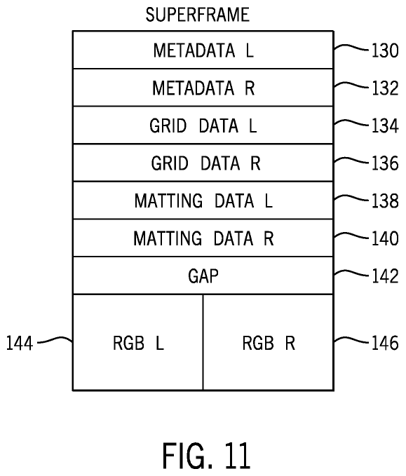

The superframe 100 may include various data types associated with the image data. FIG. 11 is a block diagram illustrating the various data types that may be included in the superframe 100, in accordance with an embodiment. Each of the illustrated various types of data may be associated with a left camera (e.g., of the cameras 16) or a right camera (e.g., of the cameras 16). As illustrated in FIG. 11, the superframe 100 may include left metadata 130, right metadata 132, left grid data 134, right grid data 136, left matting data 138, right matting data 140, a gap 142, left red, green, or blue (RGB) pixel arrangement data 144, and/or right RGB pixel arrangement data 146. The left metadata 130 and/or the right metadata 132 may include camera settings and state, statistics computed by the camera 16, image signal processing settings and state, statistics computed by the image signal processor (e.g., 64, 76), timestamps, and/or settings and state of auxiliary devices (e.g., an eye-glint LED turned on or off).

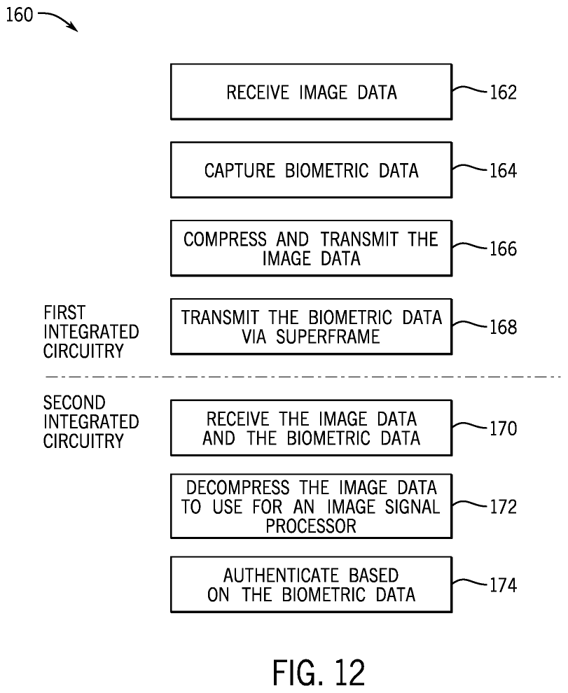

FIG. 12 is a flow diagram 160 of the transportation and consumption of the image data and the biometric data between the first integrated circuitry 52 and the second integrated circuitry 54, in accordance with an embodiment. Any suitable device (e.g., a controller) that may control components of the electronic device 10 (or an additional electronic device), such as the processor core complex 18 (or an additional processor associated with the additional electronic device), may perform the transportation and consumption of the image data. In some embodiments, the flow diagram 160 may be implemented by executing instructions stored in a tangible, non-transitory, computer-readable medium, such as the memory (e.g., 20, 78), using the processor core complex 18. For example, the flow diagram 160 may be performed at least in part by one or more software components, such as an operating system of the electronic device 10, one or more software applications of the electronic device 10, and the like. While the flow diagram 160 is described using steps in a specific sequence, it should be understood that the present disclosure contemplates that the described steps may be performed in different sequences than the sequence illustrated, and certain described steps may be skipped or not performed altogether. Further, it should be noted that the first integrated circuitry 52 and/or the second integrated circuitry 54 may perform each of the steps described below.

At block 162, the processor core complex 18 may receive, at the first integrated circuitry 52, image data from the cameras 16. For example, the processor core complex 18 may receive the image data including an image of an iris of the user. At block 164, the processor core complex 18 may capture, at the first integrated circuitry 52, the biometric data from the image data. That is, the processor core complex 18 may extract features associated with a biometric trait from the image data. As an example, the processor core complex may extract features associated with the distinctive features (e.g., a texture or unique patterns) of the iris of the user. The image data not associated with the biometric data may be separate image data. That is, a portion of the image data may be the biometric data and another portion of the image data may be the separate image data.

At block 166, the processor core complex 18 may compress and transmit, at the first integrated circuitry 52, the image data to the second integrated circuitry 54. As described herein, the processor core complex 18 may compress and transmit the image data via the streaming encoding or decoding circuitry 66 using the compression protocol. Additionally, at block 168, the processor core complex 18 may transmit the biometric data via the superframe 100 (e.g., the single frame). Indeed, the superframe compositor 68 may arrange or place each received frame of the biometric data in the superframe 100 without compressing each of the received frames. The superframe 100 may be transmitted as the uncompressed superframe to the second integrated circuitry 54 via the LPDP link 60.

At block 170, the processor core complex 18 may receive the image data and the biometric data at the second integrated circuitry 54. As described herein, the image data may be compressed before transmission. Thus, at block 172, the processor core complex 18 may decompress the image data via the streaming encoding or decoding circuitry 70 to use for the image signal processor 76. Additionally, at block 174, the processor core complex 18 may authenticate based on the biometric data. For example, the processor core complex 18 may compare the biometric data to stored biometric data in the memory (e.g., 20, 78) to determine if a similarity score exceeds a predefined threshold. Based on the authentication, access to the electronic device 10 (or any other suitable device) may be granted or denied.

Accordingly, the techniques described herein for transmitting the biometric data via the superframe 100, without compression, may enable minimization or reduction in a loss of data confidentiality, vulnerability, and/or decreased data integrity. Furthermore, transmitting the biometric data via the superframe 100, without compression, may improve latency in communication. Additionally, the techniques described herein for transmitting the biometric data via the superframe 100 while transmitting the other image data in the compressed format may improve latency in communication while maintaining the integrity of the biometric data.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible, or purely theoretical. Further, if any claims appended to the end of this specification contain one or more elements designated as “means for [perform] ing [a function] . . . ” or “step for [perform] ing [a function] . . . ,” it is intended that such elements are to be interpreted under 35 U.S.C. 112 (f). However, for any claims containing elements designated in any other manner, it is intended that such elements are not to be interpreted under 35 U.S.C. 112 (f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A system comprising:
first integrated circuitry configured to:
obtain first image data from a first camera;
obtain second image data from a second camera;
compress the first image data;
combine one or more frames of the second image data into a single frame;
transmit the first image data in a compressed form; and
transmit the second image data in an uncompressed form via the single frame via an image data transfer protocol connection; and
second integrated circuitry configured to:
receive the first image data in the compressed form from the first integrated circuitry;
decrypt the first image data;
use the first image data for display on an electronic display coupled to the second integrated circuitry;
receive the second image data via the single frame via the image data transfer protocol connection; and
perform user authentication using the second image data.

2. The system of claim 1, wherein the image data transfer protocol connection comprises a Low Power DisplayPort (LPDP) connection.

3. The system of claim 1, wherein the second image data corresponds to biometric data.

4. The system of claim 3, wherein the biometric data comprises iris identification data, continuity data, anti-spoofing data, or any combination thereof.

5. The system of claim 1, wherein the first image data comprises gaze tracking data.

6. The system of claim 1, wherein the first integrated circuitry is configured to combine the one or more frames of the second image data into the single frame via a compositor.

7. The system of claim 1, wherein each of the one or more frames of the second image data is encrypted to include a security signature.

8. The system of claim 7, comprising the second integrated circuitry configured to decrypt the security signature and perform authentication based on the second image data.

9. The system of claim 1, wherein the single frame comprises metadata, grid data, matting data, a gap, red, green, or blue (RGB) pixel arrangement data, or any combination thereof, associated with the second image data.

10. The system of claim 1, wherein the second camera is configured to operate in a security mode that causes the second camera to output a secure frame of the second image data comprising a security signature.

11. The system of claim 1, wherein the second image data is associated with one or both eyes.

12. First integrated circuitry comprising:
a first camera configured to capture first image data;
a second camera configured to capture second image data;
a first image data transfer interface configured to receive the first image data and transmit a first portion of the first image data to streaming encoding or decoding circuitry and a second portion of the first image data to a compositor; and
a second image data transfer interface configured to receive the second image data and transmit a first portion of the second image data to the streaming encoding or decoding circuitry and a second portion of the second image data to the compositor.

13. The first integrated circuitry of claim 12, wherein the streaming encoding or decoding circuitry is configured to compress the first portion of the first image data and the first portion of the second image data.

14. The first integrated circuitry of claim 13, wherein the streaming encoding or decoding circuitry is configured to transmit the compressed first portion of the first image data and the compressed first portion of the second image data to second integrated circuitry.

15. The first integrated circuitry of claim 12, wherein the compositor is configured to arrange one or more frames of the second portion of the first image data and one or more frames of the second portion of the second image data in a single frame.

16. The first integrated circuitry of claim 15, wherein the compositor is configured to transmit the single frame to second integrated circuitry via a Low Power DisplayPort (LPDP) connection.

17. The first integrated circuitry of claim 12, wherein the first portion of the first image data and the first portion of the second image data comprise gaze tracking data.

18. The first integrated circuitry of claim 12, wherein the second portion of the first image data and the second portion of the second image data comprise continuity data.

19. A system comprising:
first integrated circuitry configured to:
receive image data;
obtain biometric data from the image data;
transmit the image data via streaming encoding or decoding circuitry in a compressed form; and
transmit the biometric data in an uncompressed form via a single frame.

20. The system of claim 19, wherein the single frame comprises two or more frames of the biometric data.
